(19) United States
(12) Patent Application Publication
(10) Pub. No.: US 2007/0115406 A1
(43) Pub. Date: May 24, 2007

(54) Liquid crystal display array board and method of fabricating the same

(76) Inventor: Do Young Kim, Ulsan (KR)

Correspondence Address: CHRISTIE, PARKER & HALE, LLP, PO BOX 7068, PASADENA, CA, 91109-7068, US

(21) Appl. No.: 11/521,522

(22) Filed: Sep. 13, 2006

(30) Foreign Application Priority Data
Nov. 23, 2005 (KR) 10-2005-112593

(51) Int. Cl. G02F 1/1333

(52) U.S. Cl. 349/110

(57) ABSTRACT

A liquid crystal display array board includes a plurality of gate wiring lines formed on a substrate, a plurality of data wiring lines crossing the plurality of gate wiring lines at crossed regions, thin film transistors formed in the crossed regions and having drain electrodes, and storage capacitor first electrodes aligned in parallel to the plurality of gate wiring lines. The liquid crystal display array board also includes pixel electrodes electrically connected to the drain electrodes of the thin film transistors and includes storage capacitor second electrodes formed on regions overlapping the first electrodes, and black matrices formed on the substrate to correspond to predetermined regions of the gate wiring lines and regions in which the data wiring lines and thin film transistors are formed.

### CROSS-REFERENCE TO RELATED APPLICATION

This application claims the benefit of and priority to Korean Patent Application No. 10-2005-112593, filed on Nov. 23, 2005, in the Korean Intellectual Property Office, the entire content of which is incorporated herein by reference.

### BACKGROUND

As is well known, in the driving principle of liquid crystal displays (LCDs), optical anisotropy and polarizability of liquid crystal are used. Since liquid crystal is thin and long, an electromagnetic field is applied to liquid crystal molecules that are arranged with orientation and polarizability to control the direction in which the molecules are arranged. Therefore, when the orientation is arbitrarily controlled, light is transmitted or shielded in accordance with the orientation of the liquid crystal molecules due to the optical anisotropy of liquid crystal so that it is possible to display color and images.

In an active matrix type LCD, non-linear active devices are coupled to pixels arranged in a matrix and the operations of the pixels are controlled using the switching characteristic of the active devices so that a memory function is realized by the electro-optical effect of liquid crystal.

On the other hand, in an active matrix type LCD, in order to secure uniformity of a displayed image, it is necessary to maintain a signal voltage input through data wiring lines until a next input for a predetermined time. Therefore, a storage capacitor is formed to run parallel to liquid crystal cells.

The storage capacitor formed in the LCD is divided into an “on common” mode and an “on gate” mode in accordance with the mode in which a charge electrode is used.

The modes are compared with each other as follows. In the on gate mode, a part of an (n-1)th scan line is used as the charge electrode of an nth pixel. The scan signal time increases, the degree of reduction in aperture ratio is small, point defects generated in a normally white (NW) mode are not easily found, and the yield is high.

In the on common mode, a charge electrode is additionally provided. The scan signal time is short, the degree of reduction in the aperture ratio is large, the point defects generated in the NW mode are easily found, and the yield deteriorates.

Hereinafter, a conventional storage capacitor in an on common mode will be simply described with reference to FIG. 1.

FIG. 1 schematically illustrates an LCD array board on which the storage capacitor in the on common mode in a conventional LCD is formed.

Referring to FIG. 1, on an insulating substrate that is a lower plate (not shown), a plurality of gate wiring lines 9 and 19 and data wiring lines 10 and 20 cross in crossed regions. In a crossed region where an arbitrary data wiring line (for example, 10) and an arbitrary gate wiring line (for example, 19) cross each other, a thin film transistor (TFT) is formed. The TFT includes a source electrode 11 and a drain electrode 12, which are connected to the data wiring line 10, a gate electrode 14, which is connected to the gate wiring line 19, and a semiconductor layer 13. A pixel electrode 15 is connected to the drain electrode 12 and is separated from the scan line 19 and the signal line 10 by a uniform distance. The first electrode 16 of the storage capacitor is positioned to run parallel with the gate wiring line 19 and to cross the pixel electrode 15.

In the storage capacitor in the on common mode of the above-described structure, charges are accumulated between the pixel electrode 15 and the first electrode 16 of the storage capacitor that is formed of the same material as the gate electrode 14. At this time, the magnitude of the capacitance accumulated in the storage capacitor is determined by C=ε*A/d. Here, C, ε, A, and d represent capacitance, dielectric constant, the area of an electrode, and a distance between electrodes, respectively.

However, when the conventional storage capacitor in the on common mode is included, back light rear surface light does not transmit through the region in which the storage capacitor is included among pixel regions so that aperture ratio is reduced.

In order to secure the uniformity of an image displayed by an LCD, it is advantageous for the capacitance accumulated by the storage capacitor be large. However, when the area of the storage capacitor is increased in order to increase the capacitance, the aperture ratio is reduced so that brightness is entirely reduced.

### SUMMARY OF THE INVENTION

Accordingly, in some embodiments of the present invention an array board of a liquid crystal display (LCD) includes a plurality of gate wiring lines formed on a substrate, a plurality of data wiring lines crossing the gate wiring lines at crossed regions, thin film transistors formed in the crossed regions and having drain electrodes, and storage capacitor first electrodes aligned in parallel to the gate wiring lines. These embodiments of the array board further include pixel electrodes electrically connected to the drain electrodes of the thin film transistors and including storage capacitor second electrodes formed on regions overlapping the first electrodes, and black matrices formed on the substrate to correspond to predetermined regions of the gate wiring lines and regions in which the data wiring lines and the thin film transistors are formed.

The storage capacitor first electrodes and the pixel electrodes may be formed of transparent and conductive metal, or of a same material as that of the gate wiring lines. The storage capacitor first electrodes may be formed on a same plane as the gate wiring lines.

In one embodiment, an insulating layer is formed between the storage capacitor first electrodes and the storage capacitor second electrodes. The insulating layer may be a gate insulating layer and/or a protective layer. In one embodiment, the thin film transistors include gate electrodes, source electrodes, drain electrodes, and active layers, the source electrodes are connected to the data wiring lines, and the gate electrodes are connected to the gate wiring lines that cross the data wiring lines to define pixel regions.

One embodiment of a method of fabricating a liquid crystal display array board includes forming black matrices on a substrate in predetermined regions, forming a plurality of gate wiring lines, gate electrodes of thin film transistors, and storage capacitor first electrodes that are aligned parallel to the gate wiring lines, and forming an insulating layer on the gate wiring lines and the storage capacitor first electrodes. This embodiment further includes forming a plurality of data wiring lines that intersect the plurality of gate wiring lines and source and drain electrodes of thin film transistors on the insulating layer, forming a protective layer on the data wiring lines and the source and drain electrodes, and forming pixel electrodes electrically connected to the drain electrodes of the thin film transistors through contact holes on the protective layer, each of the pixel electrodes partially overlapping respective ones of the storage capacitor first electrodes.

In another embodiment, the predetermined regions on the substrate are predetermined regions of the gate wiring lines and regions corresponding to locations of the data wiring lines and the thin film transistors. The storage capacitor first electrodes and the pixel electrodes may be formed of transparent and conductive metal.

### BRIEF DESCRIPTION OF THE DRAWINGS

These and/or other aspects and features of the invention will become apparent and more readily appreciated from the following description of examples of embodiments, taken in conjunction with the accompanying drawings of which:

FIG. 1 schematically illustrates a liquid crystal display (LCD) array board on which a storage capacitor in an on common mode in a conventional LCD is formed;

FIG. 2 is a plan view of an LCD array board according to an embodiment of the present invention;

FIG. 3 is a sectional view taken along the line I-I′ of FIG. 2; and

FIGS. 4A to 4H are plan views and sectional views illustrating steps in a process of fabricating an LCD according to an embodiment of the present invention.

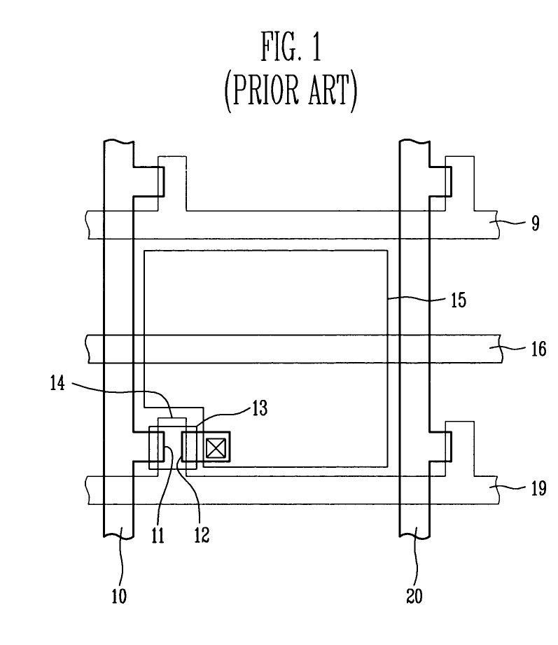

### DETAILED DESCRIPTION

Hereinafter, examples of embodiments according to the present invention will be described with reference to the accompanying drawings.

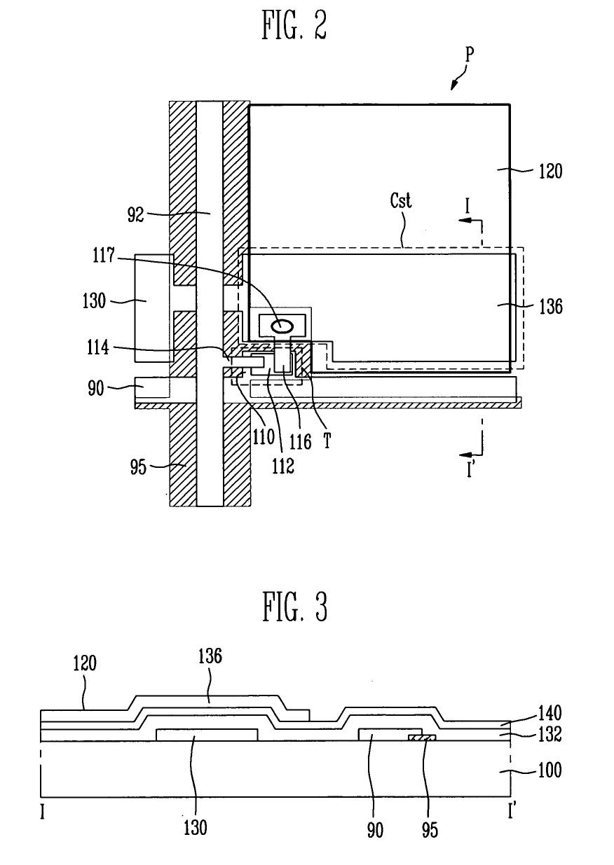

FIG. 2 is a plan view of a liquid crystal display (LCD) array board according to an embodiment of the present invention and FIG. 3 is a sectional view taken along the line I-I′ of FIG. 2.

As illustrated in FIGS. 2 and 3, the LCD array board according to this embodiment of the present invention includes a pixel region P defined by a gate wiring line 90 and a data wiring line 92 that cross each other on a first substrate 100, a pixel electrode 120, a thin film transistor (TFT) T, and a storage capacitor Cst formed on the pixel region P.

A black matrix 95 that prevents back light rear surface light from being transmitted is formed on the first substrate 100 in predetermined regions of the data wiring line 92, the gate wiring line 90 and a region in which the TFT T is formed.

Although only one pixel region P is shown, the LCD according to this embodiment of the present invention includes color filters formed in regions corresponding to a plurality of pixel regions P, black matrices formed among the color filters and in predetermined parts of a plurality of TFTs T and the storage capacitors Cst, a second substrate on which transparent common electrodes are formed on the color filters and the black matrices, and liquid crystal positioned in between the first substrate and the second substrate. Each of the TFTs T in a matrix that is a switching device is positioned on one side of a respective one of the pixel regions P.

Referring again to FIGS. 2 and 3, the pixel region P is located where the gate wiring line 90 and the data wiring line 92 cross, and the TFT T is located within the pixel region P. The pixel region P is defined by the gate wiring line 90 and the data wiring line 92 that cross each other. The pixel electrode 120 formed on the pixel region P is made of transparent and conductive metal having high transmittance of light, such as indium tin oxide (ITO).

In the LCD, a liquid crystal layer positioned on the pixel electrode 120 is oriented by the signals applied from the TFT T, and the amount of light that passes through the liquid crystal layer is controlled by the degree of orientation of the liquid crystal layer, so that it is possible to display an image.

The gate wiring line 90 transmits a pulse voltage that drives the gate electrode 110 (the first electrode of the TFT T), and the data wiring line 92 transmits a signal voltage that drives the source electrode 114 (the second electrode of the TFT T).

The TFT T includes the gate electrode 110, the source electrode 114, the drain electrode 116, and the active layer 112. The source electrode 114 is connected to the data wiring line 92 and the gate electrode 110 is connected to the gate wiring line 90 that intersects the data wiring line 92 to define the pixel region P.

That is, when a predetermined pulse voltage is applied to the gate electrode 110, the active layer 112 is activated so that the drain electrode 116 receives the signal voltage from the data wiring line 92 connected to the source electrode 114 through the source electrode 114. The source electrode 114 is separated from the drain electrode 116 by a predetermined distance through the active layer 112 and is electrically connected to the pixel electrode 120 through a contact hole 117. As a result, the signal voltage is applied to the pixel electrode 120.

A first electrode 130 of the storage capacitor is formed to run parallel to the gate wiring line 90. An insulating layer and the pixel electrode 120, which also functions as a second electrode 136 of the storage capacitor, are sequentially formed on the first electrode 130 to form the storage capacitor Cst. The insulating layer may be used as a gate insulating layer 132 and/or a protective layer 140.

According to this embodiment of the present invention, the gate wiring line 90 and the first electrode 130 are formed of a transparent and conductive metal. The black matrix 95 that prevents back light rear surface light from being transmitted is formed on the first substrate 100 in a predetermined region of the gate wiring line 90 and a region in which the data wiring line 92 and the TFT T are formed.

The second electrode 136 of the storage capacitor is used as the pixel electrode 120 so that the pixel region in which the storage capacitor is formed is used as the aperture region to prevent the aperture ratio from being reduced.

Wiring line resistance may increase since the gate wiring line 90 and the first electrode 130 are made of the transparent and conductive metal rather than conventional colored metal. However, since increase in the wiring line resistance does not matter in the LCD used for a mobile apparatus, the present invention can be applied to the LCD.

According to this embodiment of the present invention, since the first electrode 130 of the storage capacitor is formed of the transparent and conductive metal, it is not necessary to consider reduction in the aperture ratio when the area of the storage capacitor is increased. As a result, the areas of the two electrodes 130 and 136 of the storage capacitor increase so that it is possible to increase the capacitance of the storage capacitor.

Also, when the storage capacitors are constructed as described above, it is possible to reduce kickback voltages of a gate signal applied to the gate electrodes and a pixel voltage generated by coupling between the pixel electrodes so that it is possible to increase the degree of freedom in driving the LCD.

The LCD array board having the above-described structure is obtained by sequentially performing a deposition process, a photolithography process, and an etching process. In the photolithography process, a photo resist (PR) is selectively irradiated with light using a mask of a desired pattern to form the same pattern as the pattern of the mask. This is achieved through the PR generating a chemical reaction to change its characteristic when the PR is irradiated with light. The photolithography process includes a PR applying process of applying the PR corresponding to a film of a common picture, an exposure process of selectively radiating light using a mask, and a development process of removing the PR on the part irradiated with light using developer to form a pattern.

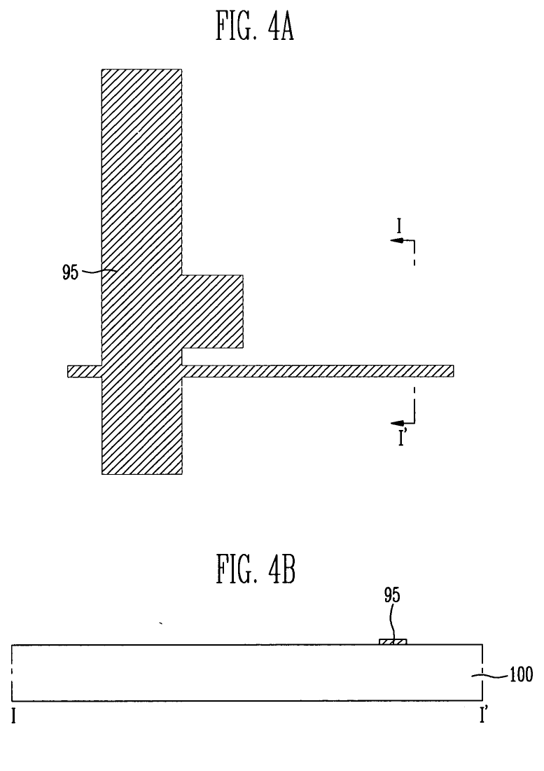

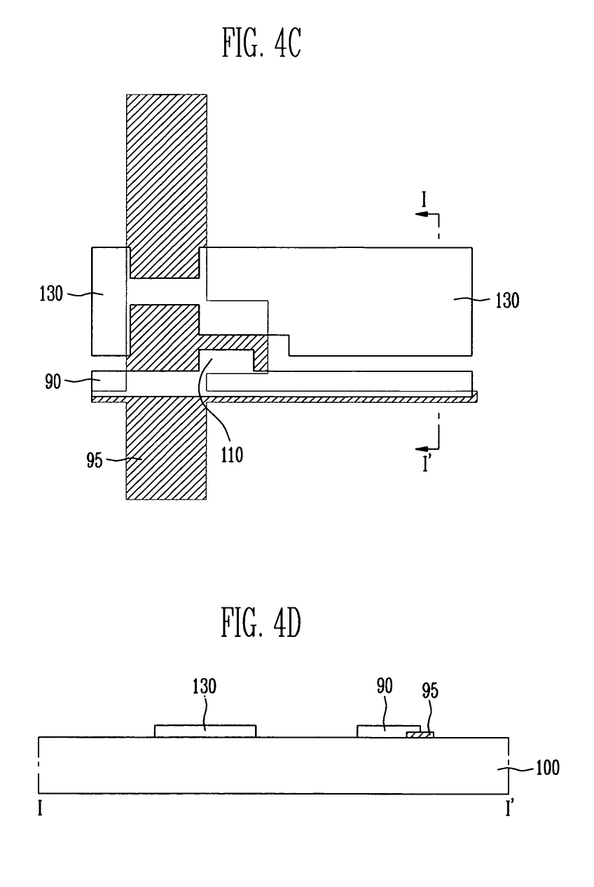

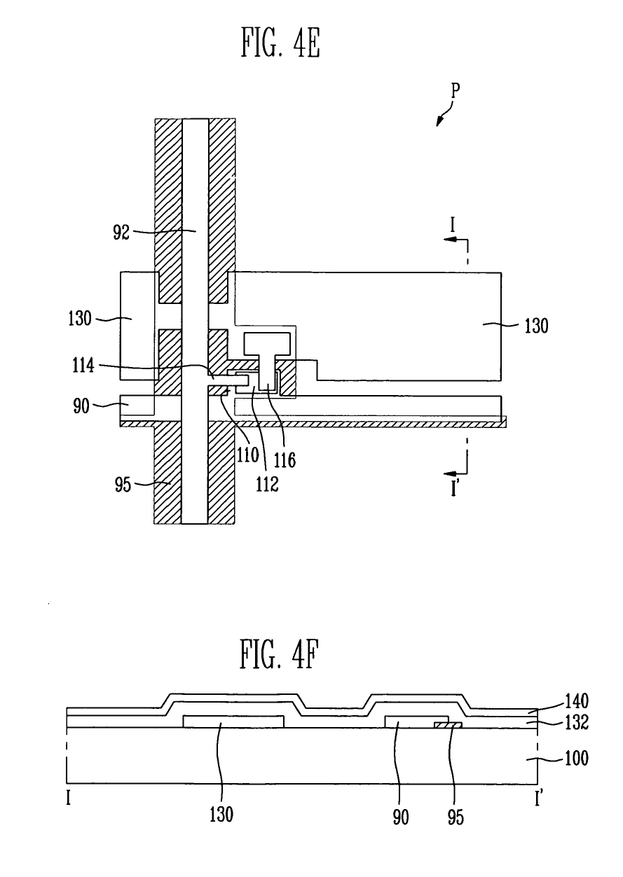

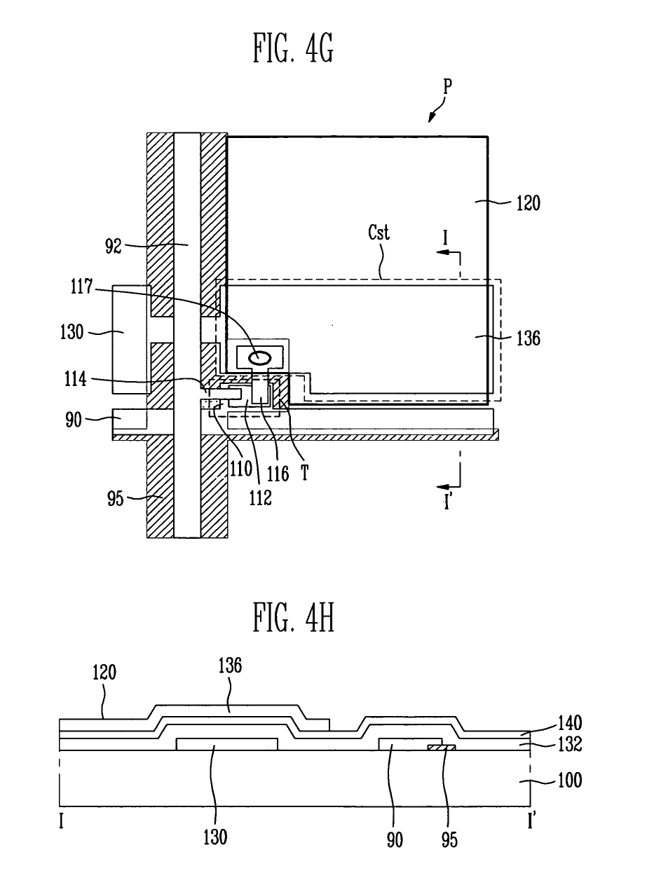

FIGS. 4A to 4H are plan views and sectional views illustrating steps in a process of fabricating an LCD according to an embodiment of the present invention.

First, referring to FIGS. 4A-4B, a material used as a black matrix is formed on the entire surface of an insulating substrate and the material is patterned and developed using a mask to form the black matrix 95 in predetermined regions of the data wiring line and the gate wiring line to be formed later and in a region of the TFT.

Next, as illustrated in FIGS. 4C-4D, a predetermined metal is deposited on the entire surface of the substrate 100 on which the black matrix 95 is formed in a predetermined region and the metal is patterned and developed using a mask to form the gate wiring line 90, the gate electrode 110, and the first electrode 130 of the storage capacitor.

According to this embodiment of the present invention, the predetermined metal is a transparent and conductive metal, such as ITO or indium zinc oxide (IZO).

Next, as illustrated in FIGS. 4E-4F, the gate insulating layer 132, an amorphous semiconductor layer (a silicon layer), an amorphous semiconductor layer (a silicon layer) containing impurities, and a conductive metal layer are deposited on the substrate 100 where the gate line 90 is formed, the data line 92 that crosses the gate line 90 to define the pixel region, the source electrode 114 that perpendicularly protrudes from the data line 92 to have a predetermined area, and the drain electrode 116 that is separated from the source electrode 114 by a predetermined distance are formed by the photolithography and etching processes.

Next, the exposed impurity amorphous silicon layer is etched using the patterned metal layer as an etching prevention layer so that the amorphous silicon layer is exposed on the source electrode 114 and the drain electrode 116 to realize the active layer 112. As a result, the TFT T composed of the gate electrode 110, the source and drain electrodes 114 and 116, and the active layer 112 is obtained.

Next, as illustrated in FIGS. 4G-4H, the protective layer 140 is formed on the substrate where the data line 92 is formed of an insulating material and is patterned so that a contact hole 117 is formed on the drain electrode 116 and that the pixel electrode 120 connected to the drain electrode 116 through the contact hole 117 is formed.

At this time, the pixel electrode 120 is formed of the transparent and conductive metal like the gate wiring line 90 in the pixel region P. The pixel electrode 120 formed in the region that overlaps the first electrode 130 is used as the second electrode 136 of the storage capacitor Cst.

That is, the pixel electrode 120 is electrically connected to the drain electrode 116 through the contact hole 117 to receive a signal voltage received through the TFT T and is formed to overlap the first electrode 130 in a predetermined region so that the pixel electrode 120 is used as the second electrode 136 of the storage capacitor.

As a result, according to the present invention, since the first electrode 130 of the storage capacitor is formed of the transparent and conductive metal, it is not necessary to consider reduction in the aperture ratio when the area of the storage capacitor is increased. Therefore, the areas of the two electrodes 130 and 136 of the storage capacitor increase so that it is possible to increase the capacitance of the storage capacitor.

According to the present invention, the first electrodes of the storage capacitors are formed of the transparent and conductive metal and the black matrices are formed on one surface of the substrate in predetermined regions of the data wiring lines and the gate wiring lines and in the regions where the TFTs are formed so that it is possible to prevent the TFTs from erroneously operating due to back light rear surface light and to increase the capacitance of the storage capacitors without reducing the aperture ratio of the LCD.

Also, it is possible to reduce kickback voltages of a gate signal applied to the gate electrodes and a pixel voltage generated by coupling between the pixel electrodes so that it is possible to increase the degree of freedom in driving the LCD.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A liquid crystal display array board comprising:
a plurality of gate wiring lines formed on a substrate;
a plurality of data wiring lines crossing the plurality of gate wiring lines at crossed regions;
thin film transistors formed in the crossed regions and having drain electrodes;
storage capacitor first electrodes aligned in parallel to the plurality of gate wiring lines;
pixel electrodes electrically connected to the drain electrodes of the thin film transistors and comprising storage capacitor second electrodes formed on region overlapping the storage capacitor first electrodes; and
black matrices formed on the substrate to correspond to predetermined regions of the plurality of gate wiring lines and regions in which the plurality of data wiring lines and the thin film transistors are formed.

2. The liquid crystal display array board as claimed in claim 1, wherein the storage capacitor first electrodes and the pixel electrodes are formed of transparent and conductive metal.

3. The liquid crystal display array board as claimed in claim 1, wherein the storage capacitor first electrodes are formed of a same material as that of the plurality of gate wiring lines.

4. The liquid crystal display array board as claimed in claim 1, wherein the storage capacitor first electrodes are formed on a same layer as the plurality of gate wiring lines.

5. The liquid crystal display array board as claimed in claim 1, wherein an insulating layer is formed between the storage capacitor first electrodes and the storage capacitor second electrodes.

6. The liquid crystal display array board as claimed in claim 5, wherein the insulating layer is a gate insulating layer and/or a protective layer.

7. The liquid crystal display array board as claimed in claim 1,
wherein the thin film transistors comprise gate electrodes, source electrodes, drain electrodes, and active layers,
wherein the source electrodes are connected to the plurality data wiring lines, and
wherein the gate electrodes are connected to the plurality of gate wiring lines that cross the plurality of data wiring lines to define pixel regions.

8. A method of fabricating a liquid crystal display array board, the method comprising the steps of:
forming black matrices on a substrate in predetermined regions;
forming a plurality of gate wiring lines, gate electrodes of thin film transistors, and storage capacitor first electrodes that are aligned parallel to the gate wiring lines;
forming an insulating layer on the gate wiring lines and the storage capacitor first electrodes;
forming a plurality of data wiring lines, that cross the plurality of gate wiring lines on the insulating layer;
forming source and drain electrodes of the thin film transistors on the insulating layer;
forming a protective layer on the data wiring lines and the source and drain electrodes; and
forming pixel electrodes electrically connected to the drain electrodes of the thin film transistors through contact holes on the protective layer, each of the pixel electrodes partially overlapping respective ones of the storage capacitor first electrodes.

9. The method as claimed in claim 8, wherein the predetermined regions on the substrate are predetermined regions of the gate wiring lines and regions corresponding to locations of the data wiring lines and the thin film transistors.

10. The method as claimed in claim 8, wherein the storage capacitor first electrodes and the pixel electrodes are formed of transparent and conductive metal.
